(19) United States
(12) Patent Application Publication
(10) Pub. No.: US 2003/0217263 A1
(43) Pub. Date: Nov. 20, 2003

(54) System and method for secure real-time digital transmission

(76) Inventor: Tsutomu Sakai, Cypress, CA (US)

Correspondence Address: Law Office Of Gerald Maliszewski, P.O. Box 270829, San Diego, CA, 92198-2829, US

(21) Appl. No.: 10/102,793

(22) Filed: Mar. 21, 2002

(51) Int. Cl. H04L 9/00

(52) U.S. Cl. 713/154; 713/171

(57) ABSTRACT

A system and method are provided for secure digital transmissions. The method comprises: accepting a digital message; compressing the digital message into a file; generating a pseudo-public-key in response to the public-key and a server device identifier; using the pseudo-public-key from a public/private-key pair to encrypt the first n bytes of the file; and, transmitting the encrypted file. In some aspects of the method, accepting a digital message includes accepting a digital message from a server device, such as a digital camera, having a serial number. Then, generating the pseudo-public-key includes using an algorithm to combine the public-key and server device serial number information. In other aspects, accepting a digital message includes accepting a digital message from a server device having a user-selectable digital code setting. Then, generating the pseudo-public-key includes using an algorithm to combine the public-key, the digital code setting, and/or the serial number. The method further comprises: receiving the encrypted file; generating a pseudo-private-key in response to the private-key and the server device identifier; using the pseudo-private-key to decrypt the first n bytes of the file; decompressing the decrypted file; and, reading the digital message.

### BACKGROUND OF THE INVENTION

1. Field of the Invention

This invention generally relates to secure information communication and, more particularly, to a system and method for securely transmitting digital information in real-time using a pseudo-public-key encryption algorithm.

2. Description of the Related Art

As noted in U.S. Pat. No. 5,535,276 (Ganesan), cryptosystems have been developed for maintaining the privacy of information transmitted across a communications channel. Often, a symmetric cryptosystem is used for this purpose. Symmetric cryptosystems, which utilize electronic keys, can be likened to a physical security system where a box has a single locking mechanism with a single keyhole. One key holder uses their key to open the box, place a message in the box and relock the box. Only a second holder of the identical copy of the key can unlock the box and retrieve the message. The term symmetric reflects the fact that both users must have identical keys.

In more technical terms, a symmetric cryptosystem comprises an encryption function E, a decryption function D, and a shared secret-key, K. The key is a unique string of data bits to which the functions are applied. Two examples of encipherment/decipherment functions are the National Bureau of Standards Data Encryption Standard (DES) and the more recent Fast Encipherment Algorithm (FEAL). To transmit a message, M, in privacy, the sender computes C=E (M,K), where C is referred to as the ciphertext. Upon receipt of C, the recipient computes M=D (C,K), to recover the message M. An eavesdropper who copies C, but does not know K, will find it practically impossible to recover M. Typically, all details of the enciphering and deciphering functions, E and D, are well known, and the security of the system depends solely on maintaining the secrecy of key, K. Conventional symmetric cryptosystems are fairly efficient and can be used for encryption at fairly high data rates, especially if appropriate hardware implementations are used.

Asymmetric cryptosystems, often referred to as public-key cryptosystems, provide another means of encrypting information. Such systems differ from symmetric systems in that, in terms of physical analogue, the box has one lock with two non-identical keys associated with it. For example, in an RSA system, either key can be used to unlock the box to retrieve a message which has been locked in the box by the other key. However, the system could be limited to using the keys in a particular sequence, such that the box can only be locked with the one key and unlocked with the other key.

In public-key electronic cryptosystems, each entity has a private-key, d, which is known only to the entity, and a public-key, eN, which is publicly known. Once a message is encrypted with a user's public-key, it can only be decrypted using that user's private-key, and conversely, if a message is encrypted with a user's private-key, it can only be decrypted using that user's public-key.

If sender x wishes to send a message to receiver y, then x, “looks-up” y's public-key eN, and computes M=E(C,e_{y}) and sends it to y. User y can recover M using its private-key d_{y}, by computing C=D(M,d_{y}). An adversary who makes a copy of C, but does not have d_{y}, cannot recover M. However, public-key cryptosystems are inefficient for large messages such as image information, even if the image information is compressed.

Public-key cryptography also provides a convenient way of performing session key exchange, after which the key that was exchanged can be used for encrypting messages during the course of a particular communications session and then destroyed, though this can vary depending on the application. One public-key cryptographic system is the Rivest, Shamir, Adleman (RSA) system. RSA is a public-key based cryptosystem that is believed to be very difficult to break.

However, the theft of keys, or computer devices embedded with private-keys, can be accomplished by a determined eavesdropper. The use of biometric data and passwords can be added as an additional security requirement, but these additional security procedures can also be easily circumvented.

DES algorithms are safer from eavesdroppers, but the increased complexity of the algorithm makes the encryption and decryption of large data files, such as real-time video information, computationally intensive. Further, DES systems suffer from problems in the distribution of master keys, especially if the transceiving partners are remotely located.

It would be advantageous if large amounts of digital information, such as compressed video or digital image files, could be securely transmitted.

It would be advantageous if large digital files could be transmitted with greater security than a conventional public-key system, but without the computational intensity of a DES system.

### SUMMARY OF THE INVENTION

The present invention describes a method and system for transferring digital contents such as data, audio, and video information over a public network, such as the Internet and local home/business network, securely protected from unauthorized information access. The invention permits a transmitting server device to be accessed from the client devices such as a personal computer (PC), personal digital assistant (PDA), or cellular telephone, either locally or remotely over a public communication system. The server devices transfer encrypted digital contents under using a pseudo-public-key cryptography algorithm that comprises a public/private-key pair, plus the unique ID of the server device that is embedded inside a nonvolatile electronic memory and/or a user selectable code setting.

By just encrypting the first n data bytes of a compressed digital file using the pseudo-public-key, an efficient protective encryption algorithm is generated that requires minimal computational processing power. Therefore, the method is well suited for real-time digital message transmission over the public network. The client device decrypts the digital contents using the known private-key, unique ID, and/or the user-selectable code setting.

Accordingly, a method is provided for secure digital transmissions. The method comprises: accepting a digital message; compressing the digital message into a file; generating a pseudo-public-key in response to the public-key and a server device identifier; using the pseudo-public-key from a public/private-key pair to encrypt the first n bytes of the file; and, transmitting the encrypted file.

In some aspects of the method, accepting a digital message includes accepting a digital message from a server device, such as a digital camera, having a serial number. Then, generating the pseudo-public-key includes using an algorithm to combine the public-key and server device serial number information. In other aspects, accepting a digital message includes accepting a digital message from a server device having a user-selectable digital code setting. Then, generating the pseudo-public-key includes using an algorithm to combine the public-key and the digital code setting.

The method further comprises: receiving the encrypted file; generating a pseudo-private-key in response to the private-key and the server device identifier; using the pseudo-private-key to decrypt the first n bytes of the file; decompressing the decrypted file; and, reading the digital message.

Additional details of the above-described method and a system for secure digital transmission are provided below.

### BRIEF DESCRIPTION OF THE DRAWINGS

FIG. 1 is a schematic block diagram of the present invention system for secure digital transmissions.

FIG. 2 is a flowchart illustrating the present invention method for secure digital transmissions.

FIG. 3 is a flowchart illustrating another aspect of the method of FIG. 2.

### DETAILED DESCRIPTION OF THE PREFERRED EMBODIMENTS

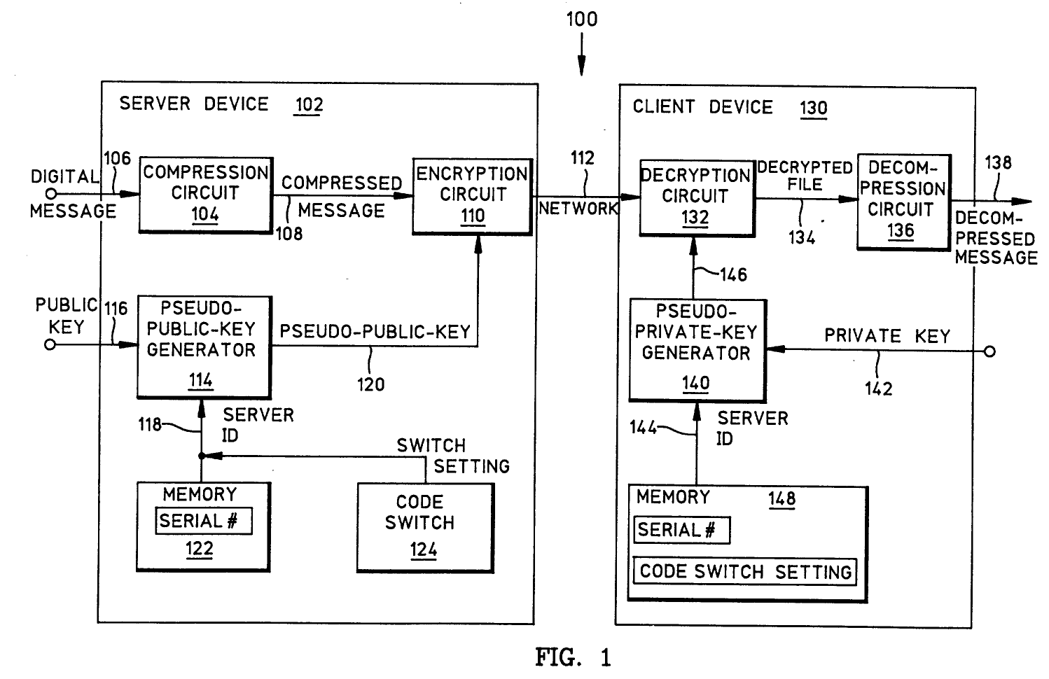

FIG. 1 is a schematic block diagram of the present invention system for secure digital transmissions. The system 100 comprises a server device 102. The server device 102 includes a compression circuit 104 having an input on line 106 to accept a digital message and an output on line 108 to supply a compressed digital message. In one aspect of the system 100, the server device 102 is a digital camera (or connected to a digital camera not shown), and the digital message on line 106 is image information. Further, the digital camera can be a video camera supplying continuous real-time image information.

An encryption circuit 110 has an input on line 108 to accept the compressed digital message and an output connected to a network on line 112 to supply a file with the first n bytes of the file encrypted in response to a public-key of a public/private-key pair. The network 112 can be the Internet, a local area network, or even a wireless telephone network, to name but a few examples. The present invention is not limited to any particular network or network protocol.

The server device 102 further includes a pseudo-public-key generator 114 having an input on line 116 to accept the public-key and an input on line 118 to accept a server device identifier. The pseudo-public-key generator has an output on line 120 to supply a pseudo-public-key generated in response to the public-key and the server device identifier. The encryption circuit 110 has an input on line 120 to accept the pseudo-public-key. In some aspects of the system, the compression circuit 104 supplies a file of x bytes, and the encryption circuit 110 selects the value of n into response to the value of x.

Although the elements of the server device have names that imply hardware, it would be typical to implement most, if not all of the elements in software.

The server device 102 further includes a memory 122 including a server device serial number and an output on line 118 connected to the pseudo-public-key generator 114 input to supply the server device identifier. Alternately but not shown, the serial number information can be supplied on another line, or supplied with the digital message. The pseudo-public-key generator 114 includes an algorithm to combine the public-key and server device serial number information into the pseudo-public-key.

In some aspects of the system 100, the server device 102 further includes a digital code switch 124 having an output on line 118 connected to the pseudo-public-key generator 114 input to supply the server device identifier in the form of a digital code setting. Alternately but not shown, the switch 124 is mounted on another device and the setting is supplied on another line or supplied with the digital message. As another alternative not shown, the switch 124 can be mounted in another device and the code setting can be kept in memory 122. The pseudo-public-key generator 114 includes an algorithm to combine the public-key and digital code switch setting information into the pseudo-public-key.

The server device identifier can be either the device serial number from memory, a digital code setting from the code switch 124 (typically user-selectable), or both. When the server device identifier includes both kinds of data, the pseudo-public-key generator 114 includes an algorithm to combine the public-key, digital code setting, and server device serial number information into the pseudo-public-key.

For example, in one pseudo-public-key algorithm, the PPK (pseudo-public-key) generator combines the PK (public-key), (SDSN) server device serial number, and DCSS (digital code switch setting) as follows:

PPK=PK\hat{ }SDSN\hat{ }DCSS

The length of PPK=the length of PK, the length of the binary number. The length of PK>length of SDSN. The length of PK is always greater than that of SDSN. The length of PK>length of DCSS. The length of PK is always greater than that of DCSN. The symbol “\hat{ }” indicates a simple algorithm like Binary XOR (Exclusive OR) or Binary function (Shift by x bit right or left of each number and Binary AND all numbers), or other similar operations.

Some aspects of the system 100 comprise a client device 130. The client device 130 can be a PC for example. The client device 130 includes a decryption circuit 132 having an input connected to the network on line 112 to accept the encrypted file and an output on line 134 to supply the file with the first n bytes of the file decrypted in response to the private-key. A decompression circuit 136 has an input on line 134 to accept the decrypted file and an output on line 138 to supply a decompressed digital message.

The client device further includes a pseudo-private-key generator 140 having an input on line 142 to accept the private-key and an input on line 144 to accept a server device identifier. The pseudo-private-key generator 140 has an output on line 146 to supply a pseudo-private-key generated in response to the private-key and the server device identifier. The decryption circuit 132 has an input on line 146 to accept the pseudo-private-key.

In some aspects, the client device 130 further includes a memory 148. The memory has an output on line 144 is connected to the pseudo-public-key generator 140 input to supply the server device identifier. In some aspects, the memory 148 includes the server device serial number. Alternately, the memory 148 includes the server device code setting of switch 124. In other aspects, both types of information are included. Then, pseudo-private-key generator 140 includes an algorithm to combine the private-key, with the server device digital code setting, and/or the server device serial number information into the pseudo-private-key (similar to the generation of the pseudo-public-key described above), depending upon the server device identifiers used to encrypt the digital message.

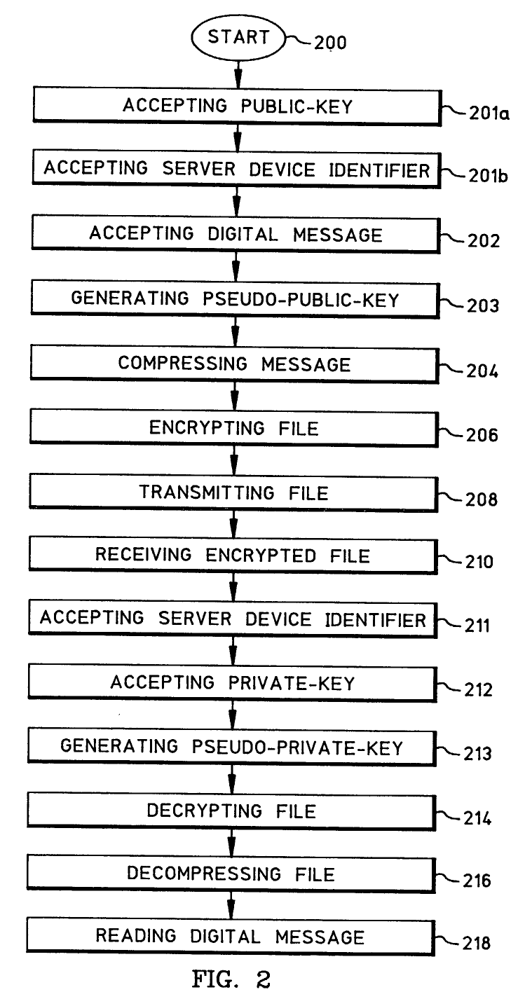

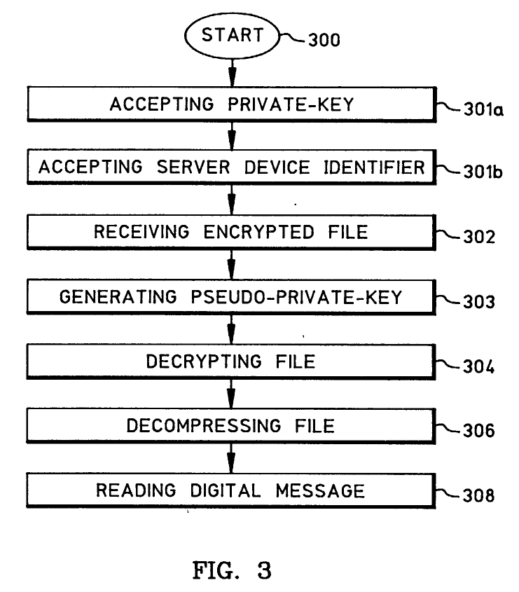

FIG. 2 is a flowchart illustrating the present invention method for secure digital transmissions. This method generally corresponds to FIG. 1. Although this method (and FIG. 3 below) is depicted as a sequence of numbered steps for clarity, no order should be inferred from the numbering unless explicitly stated. It should be understood that some of these steps may be skipped, performed in parallel, or performed without the requirement of maintaining a strict order of sequence. The methods start at Step 200. Step 202 accepts a digital message. In some aspects of the method, accepting a digital message includes accepting a digital camera image message from a digital camera server device. Step 204 compresses the digital message into a file. Step 206 uses a public-key from a public/private-key pair to encrypt the first n bytes of the file. Step 208 transmits the encrypted file.

Some aspects of the method include further steps. Step 201a accepts the public-key. Step 201b accepts a server device identifier. Step 203 generates a pseudo-public-key in response to the public-key and the server device identifier. Then, using a public-key to encrypt the first n bytes of the file in Step 206 includes using the pseudo-public-key to encrypt.

In some aspects, Step 201b includes accepting a digital message from a server device having a serial number. Then, generating a pseudo-public-key in response to the public-key and a server device identifier in Step 203 includes generating the pseudo-public-key using an algorithm to combine the public-key and server device serial number information. Alternately, Step 201b includes accepting a digital message from a server device having a digital code setting, which is typically user-selectable. Then, generating a pseudo-public-key in response to the public-key and a server device identifier in Step 203 includes generating the pseudo-public-key using an algorithm to combine the public-key and the digital code setting.

As a third, safer, alternative, Step 201b includes accepting a digital message from a server device having a serial number and a digital code setting. Then, generating a pseudo-public-key in Step 203 includes using an algorithm to combine the public-key, the digital code setting, and the server device serial number information.

In some aspects of the method, compressing the digital message into a file in Step 204 includes compressing the message into a file of x bytes. Then, using a public-key (pseudo-public-key) to encrypt the first n bytes of the file in Step 206 includes selecting the value of n into response to the value of x. That is, the number of bytes encrypted is dependent upon the size of the file. Further, the value of n is user-selectable. A larger value of n increases security at the price of information throughput.

Some aspects of the method include further steps. Step 210 receives the encrypted file. Step 211 accepts a server device identifier. Step 212 accepts the private-key. Step 214 uses the private-key to decrypt the first n bytes of the file.

Typically a further step, Step 213, generates a pseudo-private-key in response to the private-key and the server device identifier, and Step 214 uses the pseudo-private-key for the decryption. Step 216 decompresses the decrypted file. Step 218 reads the digital message.

In some aspects, generating a pseudo-private-key in response to the private-key and the server device identifier in Step 213 includes generating the pseudo-private-key using an algorithm to combine the private-key, the server device digital code setting, and/or the server device serial number information, depending upon the server device identifier information used to generate the pseudo-public-key. That is, the pseudo-private-key is generated in response to the same server device identifiers used to generate the pseudo-public-key.

FIG. 3 is a flowchart illustrating another aspect of the method of FIG. 2. The method starts at Step 300. Step 302 receives a file with the first n bytes being encrypted. Step 304 uses a private-key of a public/private-key pair to decrypt the first n bytes of the file. Step 306 decompresses the file to supply a digital message. Step 308 reads the digital message.

In some aspects Step 301a accepts the private-key. Step 301b accepts a server device identifier. Step 303 generates a pseudo-private-key in response to the private-key and a server device identifier. Then, using a private-key to decrypt the first n bytes of the file in Step 304 includes using the pseudo-private-key.

In some aspects, accepting a server device identifier in Step 301b includes accepting a server device serial number and/or a digital code setting. Then, generating a pseudo-private-key in response to the private-key and a server device identifier in Step 303 includes generating the pseudo-private-key using an algorithm to combine the private-key, with the server device digital code setting, and/or the server device serial number information, as explained above.

A system and method for secure digital transmissions using a pseudo-public/private-key pair has been presented. A few examples have been given as to how the public/private-key pair can be modified. However, the present invention is not limited to modifying the key pairs with just the server device identifiers presented in the examples. Other variations and embodiments of the invention will occur to those skilled in the art.

We Claim:

1. A method for secure digital transmissions, the method comprising:
accepting a digital message;
compressing the digital message into a file;
using a public-key from a public/private-key pair to encrypt the first n bytes of the file; and,
transmitting the encrypted file.

2. The method of claim 1 further comprising:
accepting the public-key;
accepting a service device identifier;
generating a pseudo-public-key in response to the public-key and the server device identifier; and,
wherein using a public-key to encrypt the first n bytes of the file includes using the pseudo-public-key to encrypt.

3. The method of claim 2 wherein accepting a service device identifier includes accepting a server device serial number; and,
wherein generating a pseudo-public-key in response to the public-key and the server device identifier includes generating the pseudo-public-key using an algorithm to combine the public-key and server device serial number information.

4. The method of claim 2 wherein accepting a service device identifier includes accepting a server device digital code setting; and,
wherein generating a pseudo-public-key in response to the public-key and the server device identifier includes generating the pseudo-public-key using an algorithm to combine the public-key and the digital code setting.

5. The method of claim 4 wherein accepting a service device identifier includes accepting a server device serial number and digital code setting; and,
wherein generating a pseudo-public-key in response to the public-key and the server device identifier includes generating the pseudo-public-key using an algorithm to combine the public-key, the user device digital code setting, and the server device serial number information.

6. The method of claim 5 wherein accepting a digital message includes accepting a digital camera image message from a digital camera server device.

7. The method of claim 6 wherein compressing the digital message into a file includes compressing the message into a file of x bytes; and,
using a public-key to encrypt the first n bytes of the file includes selecting the value of n into response to the value of x.

8. The method of claim 2 further comprising:
receiving the encrypted file;
using the private-key to decrypt the first n bytes of the file.

9. The method of claim 8 further comprising:
accepting the private-key;
accepting a server device identifier;
generating a pseudo-private-key in response to the private-key and the server device identifier; and,
wherein using a private-key to decrypt the file includes using the pseudo-private-key to decrypt.

10. The method of claim 9 wherein accepting a digital message includes accepting a digital message from a server device having a serial number and a digital code setting;
wherein generating a pseudo-public-key in response to the public-key and a server device identifier includes generating the pseudo-public-key using an algorithm to combine the public-key, the server device digital code setting, and the server device serial number; and,
wherein generating a pseudo-private-key in response to the private-key and the server device identifier includes generating the pseudo-private-key using an algorithm to combine the private-key, the server device digital code setting, and the server device serial number.

11. The method of claim 10 further comprising:
decompressing the decrypted file; and,
reading the digital message.

12. A method for secure digital transmissions, the method comprising:
receiving a file with the first n bytes being encrypted;
using a private-key of a public/private-key pair to decrypt the first n bytes of the file;
decompressing the file to supply a digital message; and,
reading the digital message.

13. The method of claim 12 further comprising:
accepting the private-key;
accepting a server device identifier;
generating a pseudo-private-key in response to the private-key and the server device identifier; and,
wherein using a private-key to decrypt the file includes using the pseudo-private-key to decrypt.

14. The method of claim 13 wherein accepting a server device identifier includes accepting information selected from the group including a server device serial number and a digital code setting; and,
wherein generating a pseudo-private-key in response to the private-key and a server device identifier includes generating the pseudo-private-key using an algorithm to combine the private-key, with server device identifiers selected from the group including the server device digital code setting and the server device serial number.

15. A system for secure digital transmissions, the system comprising:
a server device including:
a compression circuit having an input to accept a digital message and an output to supply a compressed digital message; and,
an encryption circuit having an input to accept the compressed digital message and an output connected to a network to supply a file with the first n bytes of the file encrypted in response to a public-key of a public/private-key pair.

16. The system of claim 15 wherein the server device further includes:
a pseudo-public-key generator having an input to accept the public-key and a server device identifier, and an output to supply a pseudo-public-key generated in response to the public-key and the server device identifier; and,
wherein the encryption circuit has an input to accept the pseudo-public-key.

17. The system of claim 16 wherein the server device further includes:
a memory including a server device serial number and an output connected to the pseudo-public-key generator input to supply the server device identifier in the form of the serial number; and,
wherein the pseudo-public-key generator includes an algorithm to combine the public-key and server device serial number information into the pseudo-public-key.

18. The system of 16 wherein the server device further includes:
a digital code switch having an output connected to the pseudo-public-key generator input to supply the server device identifier in the form of a digital code setting; and,
wherein the pseudo-public-key generator includes an algorithm to combine the public-key and digital code setting information into the pseudo-public-key.

19. The system of claim 18 wherein the server device further includes:
a memory including a server device serial number and an output connected to the pseudo-public-key generator input to supply the server device identifier in the form of the serial number; and,
wherein the pseudo-public-key generator includes an algorithm to combine the public-key, digital code setting, and server device serial number information into the pseudo-public-key.

20. The system of claim 19 wherein the server device is a digital camera.

21. The system of claim 20 wherein the compression circuit supplies a file of x bytes; and,
wherein the encryption circuit selects the value of n into response to the value of x.

22. The system of claim 16 further comprising:
a client device including:
a decryption circuit having an input connected to the network to accept the encrypted file and an output to supply the file with the first n bytes of the file decrypted in response to the private-key; and,
a decompression circuit having an input to accept the decrypted file and an output to supply a decompressed digital message.

23. The system of claim 22 wherein the client device further includes:
a pseudo-private-key generator having an input to accept the private-key and a server device identifier, and an output to supply a pseudo-private-key generated in response to the private-key and the server device identifier; and,
wherein the decryption circuit has an input to accept the pseudo-private-key.

24. The system of claim 23 wherein the client device further includes:
a memory including a server device identifier selected from the group including the server device serial number and the server device digital code setting, and an output connected to the pseudo-private-key generator input to supply the server device identifier; and,
wherein the pseudo-private-key generator includes an algorithm to combine the private-key, with information selected from the group including the server device digital code setting and server device serial number information, into the pseudo-private-key.

25. A system for secure digital transmissions, the system comprising:
a client device including:
a decryption circuit having an input connected to a network to accept a file with the first n bytes encrypted and an output to supply the file with the first n bytes of the file decrypted in response to the private-key; and,
a decompression circuit having an input to accept the decrypted file and an output to supply a decompressed digital message.

26. The system of claim 25 wherein the client device further includes:
a pseudo-private-key generator having an input to accept the private-key and a server device identifier, and an output to supply a pseudo-private-key generated in response to the private-key and the server device identifier; and,
wherein the decryption circuit has an input to accept the pseudo-private-key.

27. The system of claim 26 wherein the client device further includes:
a memory including a server device identifier selected from the group including the server device serial number and the server device digital code setting, and an output connected to the pseudo-public-key generator input to supply the server device identifier; and,
wherein the pseudo-private-key generator includes an algorithm to combine the private-key, with server device identifiers selected from the group including the server device digital code setting and server device serial number information, into the pseudo-private-key.
